(19) United States
(12) Patent Application Publication
(10) Pub. No.: US 2015/0052144 A1
(43) Pub. Date: Feb. 19, 2015

(54) COMPUTER SYSTEM STORING CONTENT INTO APPLICATION INDEPENDENT OBJECTS

(71) Applicant: Francesco Mari, Cernusco sul Naviglio (MI) (IT)

(72) Inventor: Francesco Mari, Cernusco sul Naviglio (MI) (IT)

(21) Appl. No.: 14/323,579

(22) Filed: Jul. 3, 2014

Related U.S. Application Data
(60) Provisional application No. 61/845,657, filed on Jul. 12, 2013.

(51) Int. Cl. G06F 17/30

(52) U.S. Cl. CPC G06F 17/30598
USPC 707/740

(57) ABSTRACT

Computer systems (useful primarily for personal and workgroup productivity) storing content into application independent objects organized in a hierarchical structure where each object is associated with one or more hierarchical nodes and is linked to a set of characteristics including attributes and applications that can be invoked to perform defined actions on the object's content. An application programming interface (API) is provided for the development of applications aimed at performing actions on the objects. Objects are preferably stored as records in database repositories which can be locally or remotely (e.g., cloud) located.

### RELATED APPLICATIONS

This application claims the benefit of U.S. Provisional Application 61/845,657 filed 12 Jul. 2013.

### FIELD OF THE INVENTION

The present invention relates to computer based information management systems, and more particularly to such systems useful for executing personal and workgroup productivity tools.

### BACKGROUND OF THE INVENTION

Technologies and systems that people use to manage information for personal and workgroup productivity are articulated around a limited number of discrete paradigms, most of them many decades old. Even the currently widely adopted and sophisticated applications, such as Microsoft Word, Microsoft Excel and Microsoft PowerPoint, from an architectural standpoint, are similar to early word processors or spreadsheet managers created more than thirty years ago. Among the commonalities these applications share, it is important to mention:
Data, application logic and presentation tend to be tightly coupled, i.e.: data “exists” to be managed almost exclusively by a single application, and to a large extent the application also determines the way data is presented to users, and consumed;
Information is memorized in dedicated files directly stored in the file system of the computers;
Cross-category exchange of data is limited, and mostly still relies on rudimentary methods like copy and paste, links and attachments.

These applications and their characteristics, and their structural limitations, shape the way almost all people learned to work with computers, especially since the standardization of Personal Computers and Personal Information Management Systems in the late 1980's, to the point this way of working is soon as natural and unavoidable whereas it is indeed completely artificial and driven purely by technical decisions made when IT was a far more rudimentary field than today.

When a human being initiates an activity, her normal, unconditioned and unconstrained approach considers at the same time the information needed to do the job, and the process and tools she will use in an interactive and iterative fashion. On the contrary, currently available computer applications more or less all follow a rigid paradigm in which the first mandatory decision is the selection of the application itself, and this decision conditions and has enormous implications for everything that comes after, also considering that in the real world a single application is often not enough to fulfill all the requirements of a given task

With a concrete example an executive assistant entering in a meeting should be able to focus on his task, which is “writing meeting minutes”, as he would do if he were going to execute his work using paper and pencil. But in the current world his first action is to decide whether to open Microsoft Word, Microsoft Excel or Microsoft PowerPoint, or another similar application, and this initial decision determines the way the work is performed afterwards, and the deliverable he will produce. Reverting that decision and switching to another application, usually necessitates significant manual work for transferring and reformatting content.

Looking backward, it is easy to track the roots of this issue to a time in which computers and operating systems were significantly less powerful and sophisticated than today. Applications were built with limited and narrowly focused capabilities, and data organized around files strictly associated to the program used to create and edit them. From this point of view, one could observe that even the powerful Microsoft Excel application is still fundamentally similar to an early spreadsheet manager, VisiCalc, originally released to the market more than 30 years ago.

It is important to notice that the adherence to this paradigm, which is deeply ingrained in the experience of computer users to the point that it is probably seen as the only practical model, is arguably one of the most significant factors negatively impacting the effectiveness—and enjoyment—of people when they manage information using IT productivity tools.

While existing personal productivity tools typically organize information in files, available technologies offer an alternative approach utilizing databases. A database comprises an organized collection of data typically organized to model relevant aspects of reality in a way that supports processes requiring this information. Modern Database Management Systems also make available sophisticated functionalities such as data replication and storage of BLOBs (Binary Large Objects).

### SUMMARY OF THE INVENTION

The present invention is directed to a computer system, and method of operation, organized to enable a user to more intuitively manage information and achieve greater productivity. More particularly, a system in accordance with the invention, instead of boxing the contents managed by IT productivity tools in files “owned” by specific applications and storing these files in the file system of computers and networks, represents content information as application independent objects stored as records in one or more databases.

The implications created by this fundamental architectural change are manifold and produce deep consequences. First and foremost, from a user perspective, the starting point and focus moves away from the applications, and instead goes to the content on which users need to work. While a traditional Microsoft Office user is constrained by the selection of a specific application to operate on a specific document, users employing an embodiment of the present invention work on an open canvass where they can flexibly organize their contents effectively employing different tools (i.e.: applications) on different sections of the same document, therefore freeing the content from the limitation of being rigidly associated with only one (category of) application(s). A document created with an embodiment of this invention is formed from a multiplicity of application independent objects that can incorporate different types of content.

Even better, system embodiments of this invention enable the same content to enact different behaviors depending on the context. For example, a sentence of a business report can become a to-do item for another user implementing a concept of different applications overlaying on compatible content types, the present invention eliminates the need of duplicating and disconnecting information that users need to consume in different manners and for different purposes.

Traditionally, files are physically stored in specific locations of a file system, primarily organized through only one criterion (workaround such as aliases and shortcuts are available, but tend to be quite cumbersome, and therefore not widely adopted by users), whereas application independent objects managed by embodiments of the present invention are linked to one or more nodes of a hierarchy, allowing a very effective categorization of information. A specific document can be connected for example, to the project it describes, but also to the names of its author, and to the customers involved in the project.

Moreover, objects organized in a hierarchical structure can be very effectively stored as records in databases instead of a file system. Databases make available many important features that can be employed in productivity systems, enabling among others a significantly more flexible and effective cloud-based approach to workgroup collaboration.

In the context of the present invention, objects are application independent and have one or more of the following characteristics:
Objects—contain content data of variable size, i.e., the content can be as small as a single word, or as large as an Encyclopedia, in general objects managed by system embodiments of this invention will typically be smaller than a typical Microsoft Office file, because the content traditionally stored in a single file will preferably be segmented in multiple objects;
Objects are organized in a hierarchical structure with each object being linked to at least one, and more typically multiple, nodes of a hierarchy;
Objects are associated with an arbitrary number of attributes organized in an attribute catalog. Attributes can be created and managed either by the system, and therefore automatically assigned with default values to new objects, by applications or directly by users;
Objects can contain other objects, and when they do, the contained objects inherit the attributes of the parent object;
Objects can have a user-defined name that helps the users to interact with said objects;
Objects can be easily split, for example assigning a different attribute to at subset of the content or connecting a subset of the content to a different node of a hierarchy, or re-grouped together, when differentiating attributes are not required anymore;
Objects have no restrictions in terms of content type they can contain. For example, beside text and numbers, an object can contain a picture, a video, a bitmap, or a vector chart.

An application independent object in accordance with the present invention is therefore defined as a collection of data connected to the same node of a hierarchy, sharing the same attributes, and having the same content type. Objects so defined can be stored as records in a database.

A preferred system in accordance with the invention (FIG. 1) includes multiple subsystems comprising a multiplatform client, a Central Management and Access subsystem, a private cloud system and a public cloud system. Additionally, a preferred embodiment of the invention preferably also includes a Development Environment (not depicted in FIG. 1) aimed at supporting the creation of applications running inside the multiplatform client.

A preferred multiplatform client can be advantageously employed by users to manage and consume information organized in objects and hierarchies, through applications that can be installed and executed inside the multiplatform client and run on top of an Application Programming Interface (API). The multiplatform client can run on various operating systems such as Microsoft Windows, Apple OSX and Linux, on mobile platforms such as Apple iOS, Windows Mobile and Google Android, and its functionalities can also be accessed through a web browser. In general, the architecture of the multiplatform client is such that it can be easily ported on other operating systems and platforms.

The application independent objects managed by the system are preferably stored as records in a database residing in the memorization support of the device executing the multiplatform client, but also on public and private clouds, enabling secure workgroup collaboration, and effective sharing of information. Objects stored as records in a database residing in the cloud, be it private or public, are reachable by the user on any connected device using the appropriate client, even in mobility or while working on a public computer. The location of the database used for storage of the application independent objects is determined at object level and can be changed at any time. Moreover, objects stored as records in a database in the cloud can be replicated and synchronized locally for off-line access.

A preferred main user interface included in the multiplatform client functions as an Object Navigator that allows users to interact with the system, including performing one or more of the following actions with respect to stored application independent objects.
Navigate through the objects hierarchy;
Create, delete, rename, split, merge, copy and move objects;
Create a new link between a given object and a node in a hierarchy;
Search and filter objects based on their name, content or attributes;
Assign, edit or delete attributes for any existing object;
Define where and how an object is stored (inclusive of a local storage, and private and public cloud options) by setting specific attributes;
Save a snapshot of a section of a hierarchy, that includes the contents and the value of all the attributes of all the objects included in the selected part of the hierarchy;
Manage, view and restore saved snapshots;
Invoke an application to perform a defined action on the content and attributes of an object, like, for example, editing or formatting the content of such object.

Users can install numerous applications inside the multiplatform client. Applications make available discrete sets of functionalities aimed at performing certain actions on applicable objects based on their content and attributes. Every object, based on its characteristics, exposes its content and attributes to applications that can perform various operations, and consistently add or change attributes, and also change the content of the object itself. Applications can also add presentation-relevant behaviors, for example determining how contents are showed on the screen or printed. Applications can be invoked to perform actions on objects based on the type of content of the object Multiple applications can perform actions on the same type of content, providing overlaying flexible and specialized functionalities.

It is contemplated that various productivity applications will run in the system, including, but not limited to:
A word processor;
A spreadsheet manager;
A database manager;
A business chart manager;
A slide-oriented presentation manager;
A task/to-do manager;
An outline manager;
A Macro-Language Editor and Manager;
A Workflow Editor and Manager.

A preferred Central Management and Access subsystem maintains the complete repositories of relevant entities that are required for the functioning and management of the system and provides services to the active users of the system Central repositories of active users, content types and applications are included in the Central Management Subsystem. Users can access the Central Management and Access subsystem to download and install new applications. The preferred Central Management and Access subsystem also makes available to active, registered users a web access to a virtual multiplatform client, and a public cloud system.

Embodiments of the present invention include, but are not limited:
Flexible and intuitive organization of the information. Rather than segregating information in separate and discrete files associated with specific applications and managed at operating system level, information is articulated in application independent objects organized through a hierarchical structure;
Flexible and intuitive interaction between content and applications. Rather than having to define upfront the application used to perform a certain action, which becomes the only, or at least the main, tool that the user can employ, applications can be invoked at any point in time on any section of compatible content, even overlaying with each other, for example treating a section of a text document as a task with specific characteristics associated (including, but not limited to responsible person, deadline, or priority);
Flexible and intuitive storage of information. Rather than organizing information in discrete files that are stored in a specific and univocal location of the file system, information is contained in application independent objects organized in a hierarchical structure that can be stored in different locations, including, but not limited to, a local device, a private and a public cloud. Objects and hierarchies stored in a public or private cloud enable secure and smooth workgroup collaboration and workplace virtualization. Moreover, objects and hierarchies stored in a public or private cloud can be synchronized with local devices for off-line access;
Flexible and effective introduction of innovation enabled by the development of new applications. Rather than having to perform complex and costly upgrades, new or evolved applications can be loaded inside the system in a continuous manner whenever a new need emerges and a solution is made available.

### BRIEF DESCRIPTION OF THE DRAWINGS

So that the manner in which the above described features, advantages and objects of the present invention are attained and can be understood, a more particular description of the invention, briefly summarized above, may be had by reference to the appended drawings wherein:

FIG. 1 is a block diagram depicting a preferred system embodiment of the invention.

FIG. 2 illustrates the structural organization of the multiplatform client of FIG. 1.

FIG. 3 illustrates the structure and relationships of the main data categories and entities underpinning an exemplary embodiment of the invention.

FIG. 4 depicts a more detailed representation of the relationships between exemplary objects and a hierarchical structure in a system in accordance with the invention.

FIG. 5 illustrates the structure and components of the Central Management and Access subsystem of FIG. 1.

FIG. 6 illustrates a workflow with activities that a user can perform on a system in accordance with the invention.

FIG. 7 illustrates exemplary content of the object and hierarchy repositories at relevant steps of the workflow illustrated by FIG. 6.

### DETAILED DESCRIPTION

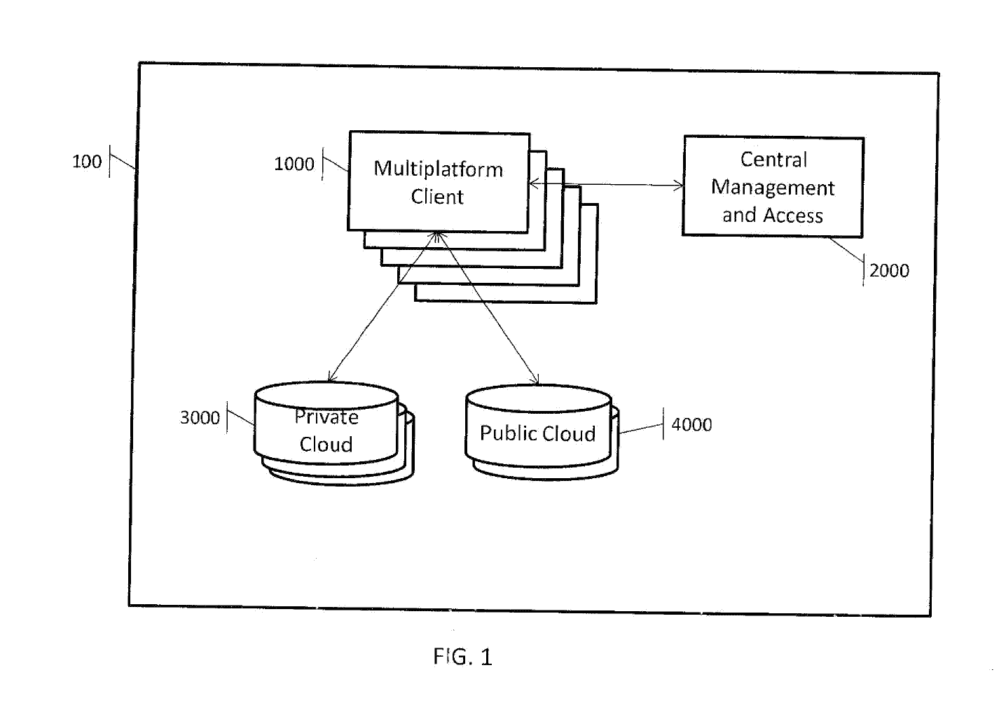

Embodiments of the invention comprise computer systems configured for efficient and flexible management of personal and workgroup information where disparate types of content are managed through multiple applications acting on application independent objects organized in a hierarchical structure. FIG. 1 is a simplified block diagram depicting the main functional components of an exemplary computer system 100 in accordance with the invention which can be executed on known computing devices having adequate processor and memory capabilities. The exemplary system 100 includes;
A Multiplatform Client (1000), which is the primary subsystem for interacting with users;
A Central Management and Access subsystem (2000) aimed at providing services to all the active users of the systems embodiment of the invention;
A Private Cloud system (3000), designed to be hosted in a secure environment to support workgroup collaboration, storage, synchronization and exchange of information among users belonging to the same organization, or in general, users authorized by the hosting entity;
A Public Cloud subsystem (4000), designed to allow workgroup collaboration, storage, synchronization and exchange of information among registered users.

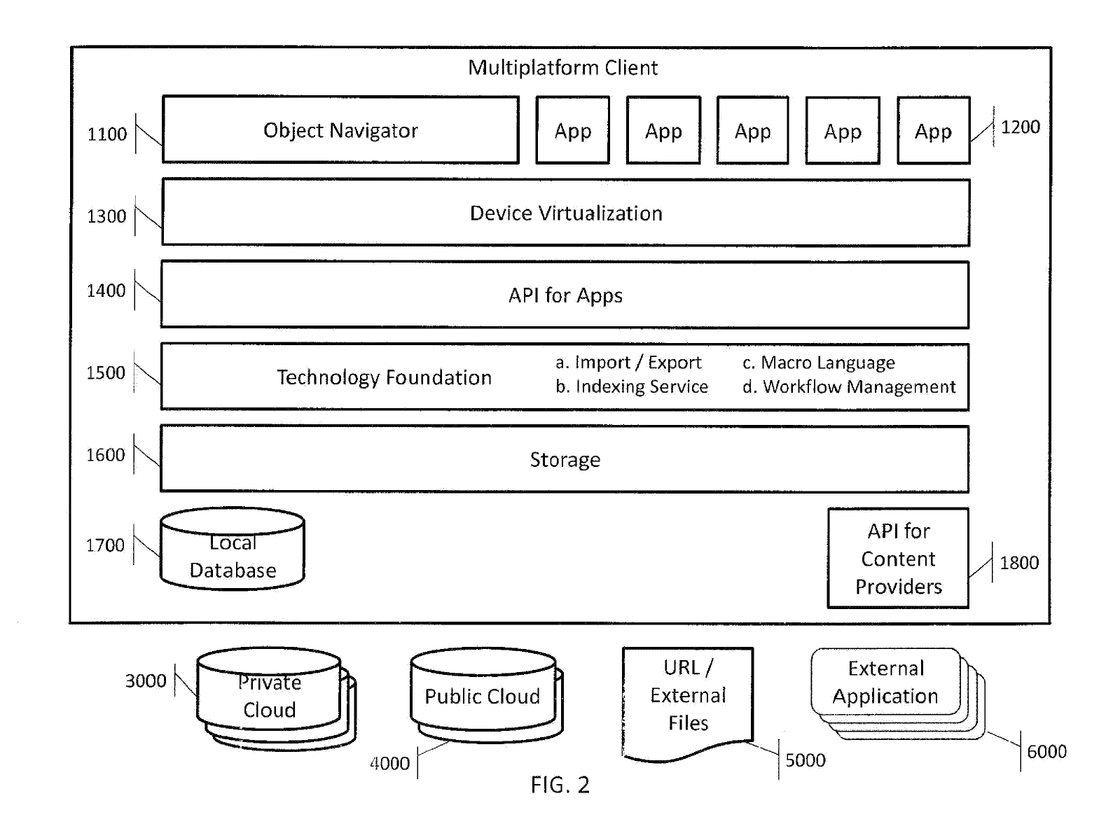

An exemplary structure of the Multiplatform Client (1000) is depicted in FIG. 2. Its main component comprises an Object Navigator (1100), which provides the basic user interface of the system, and addresses two main purposes; navigation, management and administration of the hierarchy of application independent objects, and editing of the objects so as to invoke the appropriate applications. The Object Navigator can be variously configured such that its user interface, for example, comprises a web browser capable of execution, on a mobile device, e.g., a smart phone. The Object Navigator (1100) sits on top of the Device Virtualization layer (1300) and therefore is portable across multiple devices, operating systems and platforms, including, but not limited to: Microsoft Windows, Apple OSX, Apple iOS, Google Android, Linux.

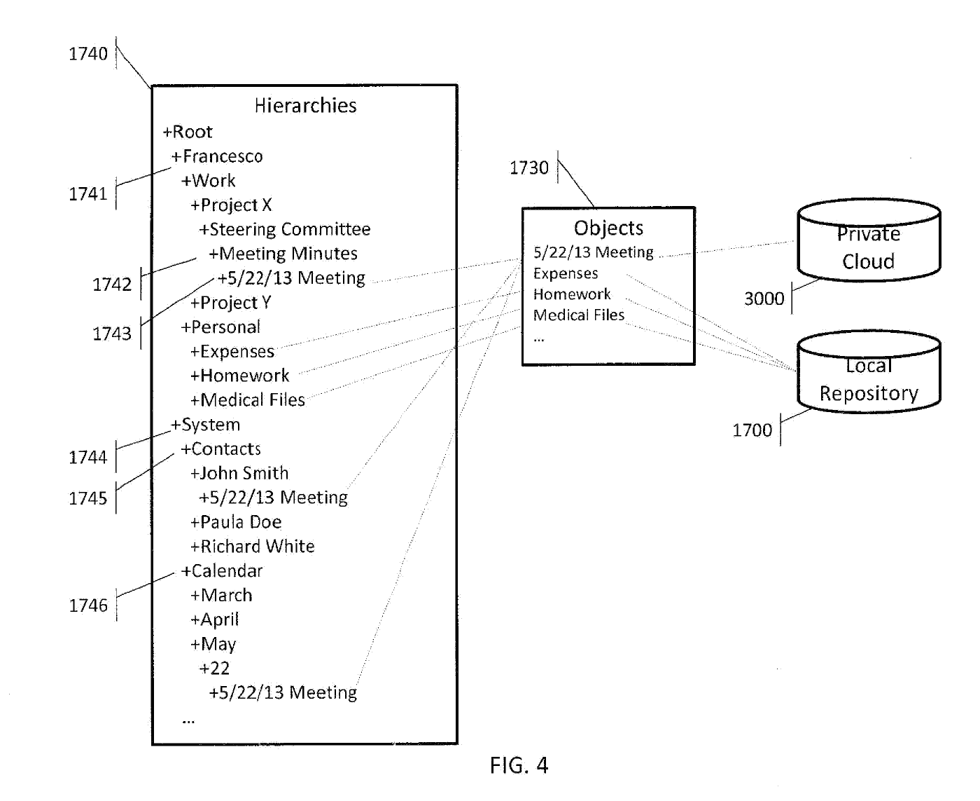

The Object Navigator (1100) has two main interaction modes:
A Hierarchy View, where users can navigate and interact with the hierarchy (1740, FIG. 4) and the stored objects (1730) for example to create, copy, move or delete an object to connect an object stored as records in a database residing in a cloud to a local hierarchy, or to change manually the attribute of an object, for example to define how a remotely stored object is synchronized;
A Content View, where users can interact with the content of the objects, and invoke applications to change said content.

Users can easily switch between the two views, for example by selecting an object and invoking an application while in the Hierarchy View of the Object Navigator. The Object Navigator (1100) also provides authentication services for users accessing the Multiplatform Client, aimed at enabling multi-user mechanisms for a single multiplatform client, and to provide access to cloud systems.

Applications can either have a user interface on their own, or provide their services inside the user interface of the Object Navigator (1100). This last case allows users to invoke multiple applications to work smoothly on objects belonging to the same part of a hierarchy (e.g.: a document composed of multiple objects). Specifically, in this case, the Object Navigator visualizes the content of the various objects belonging to the node of the hierarchy selected by the user using the appropriate viewers; then, when the user selects a section of the content, the relative application is invoked and its functionalities are enabled and made available.

Preferred system embodiments of the invention enable the creation of applications that take advantage of defined subsets of the infrastructural capabilities of the systems. For example, an application can exploit only the synchronization services made available by the Storage Layer (1600).

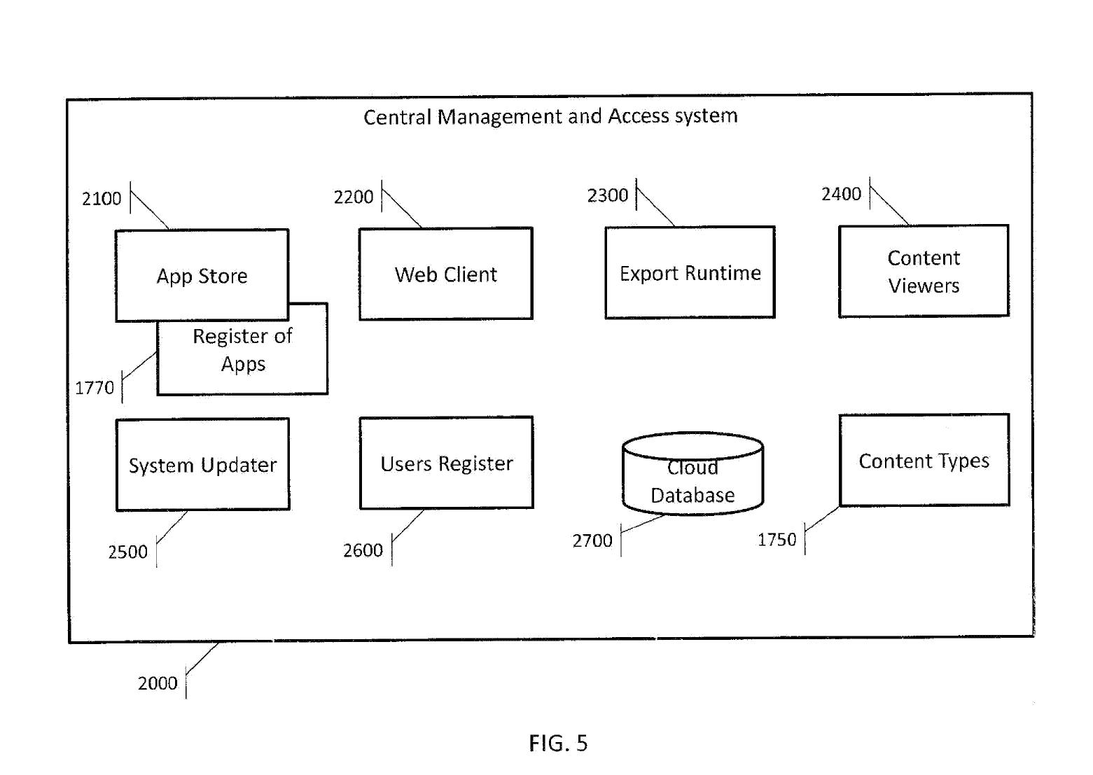

The Object Navigator (1100) also enables users to access the Central Management and Access subsystem (1000) to download new or updated applications and update their instances of the multiplatform client. The Object Navigator also enables users to connect and authenticate to Public (4000) and Private (3000) Cloud systems. The correction configurations are stored as objects in a dedicated, system-run section of the object hierarchy. Users can elect to replicate the connection information in the User Register (2600) of the Central Management and Access subsystem (FIG. 5) to allow and facilitate the access to their cloud-stored object when using the system through the Web Client (2200).

The Object Navigator also allows the definition and application of predefined settings that can be assigned to specific sections of the hierarchy to easily configure the attributes of the objects included in these sections accordingly to typical use cases, including personal information shared with other members of the same household, or highly classified project data. These settings include, but are not limited to:
Security and authorization;
Storage (local, private or public cloud);
Versioning;
Synchronization.

FIG. 2 depicts multiple Applications (1200) on which the system (100) relies to manipulate the content and the attributes of the application independent objects (1730, FIG. 4). The relationship between types of objects and applications is many-to-many, meaning that an application can work or multiple types of objects, but also that a type of object is not strictly assigned to one and only one application. This relationship differs significantly compared to a traditional file-oriented paradigm where the file extension (e.g., doc) typically rigidly determines the single application (or at least the type of application) that can work with a given file.

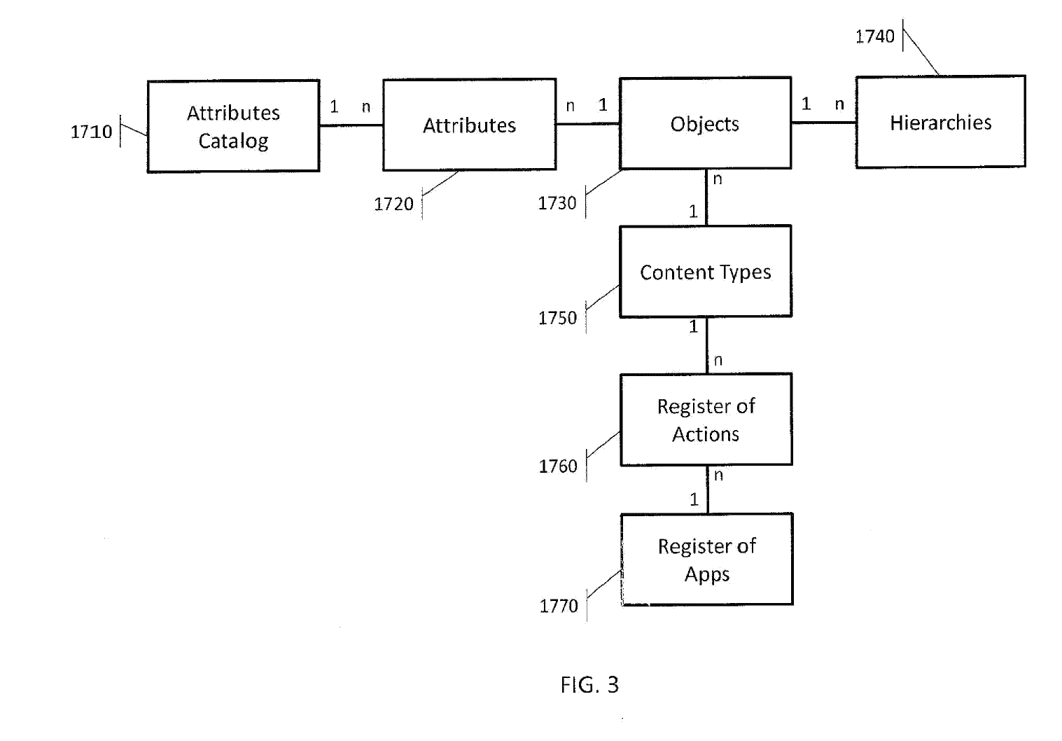

FIG. 3 depicts an exemplary organization of the database employed for storing application independent objects, showing the relationship between said objects 1730 and other data categories including a register of available applications (1770) and a connected register of actions (1760) that links actions to the types of contents (1750) that the objects (1730) can contain. The register of content types is maintained and updated centrally by the Central Management and Access subsystem (2000), and distributed to every single instance of the Multiplatform Client (1000) through an automatic distribution system. The register of available applications and actions is maintained and updated by the system locally every time that a new or updated application is loaded in the system and made available to the active users of the system.

Applications can be shipped either as part of the original packaging of the system, or added to the system in a later phase with a downloading mechanism (2100) (FIG. 4) available inside the Central Management and Access subsystem (2000), potentially with the payment of a fee. Applications can also provide templates containing structures and objects addressing specific use cases. Applications can either be fully portable across multiple devices, operating systems and platforms, or take advantage of specific features that are not available on some of the platforms, such as handwriting, and therefore limiting the portability to specific categories of devices supporting that feature. Among the information recorded in the Register of Apps (1770) (FIGS. 3,4), there is the list of the platforms for which the application is available. To ensure proper interoperability, every app must make available certain actions in all the devices, platforms and operating systems supported, including but not limited to: visualization of the content of the object, import and export of the content of the object. Moreover, every application must also make available a Content Viewer (2400) that can be freely downloaded by users who are part of a workgroup environment in which another participant used an application they don't have available on their specific configuration of the system. Whenever a user tries to visualize the content of an object with a content type that is not associated to any application in his specific instance of the system, the viewer is downloaded from the Central Management and Access subsystem, if not already available, and invoked.

A Device Virtualization (1300) layer (FIG. 2) functions to insure that both native and external applications (including the Object Navigator (1100)) can be smoothly executed across multiple platforms, operating systems and devices. The device virtualization acts as abstraction layer that translate bi-directionally computer instruction between the technology foundation and API of the system and the applications sitting on top of it.

An Application Programming interface (API) for Applications (1400 (FIG. 2) makes available to applications running in the system all the services required to interact with the Technology Foundation, including but not limited to: manipulation of objects, their content and attributes, manipulation of hierarchies, split and aggregation of objects, orchestration of the visualization of contents. Together with the Application Programming interface, an Application Development Environment is made available to support the development and maintenance of new applications.

As depicted in FIG. 2, a Technology Foundation (1500) layer implements the services called by the API and required by the functioning of the system, including, but not limited to:

Import and Export (1500a) of contents, accessible through dedicated functionalities of the Object Navigator. The Import service takes as input files created by standard, file-oriented productivity applications and standard formats like ASCII and CSV and imports the content in an object created in a node of the hierarchy selected by the user. The type of source files determines the content type (1750) to which the new object is associated. For example, importing a Microsoft Word file, the resulting object is associated to the “Formatted Text” type of content, which is associated through the register of actions (1760) with the “Word Processor” application. The Import service can also take as input a file created by the Export service of another instance of the multiplatform client, and in this case produces in the selected node of the hierarchy an exact copy of all the exported objects, employing contents and metadata describing the attributes of the objects.

The user invokes the Export service by selecting an object and then activating the corresponding Object Navigator functionality. The object selected and all its children are exported. In order to provide compatibility with existing productivity systems, the export service creates a file that contains the following components:
Metadata and contents of all the objects and their attributes, that can be imported in another instance of the multiplatform client through the Import service;
A file in Adobe Acrobat format (PDF) that contains the print of all the objects included in the hierarchy node to be exported, formatted invoking the appropriate services of the applications connected to the objects through the Content Type (1750), Register of Actions (1760) and Register of Apps (1770) repositories (FIG. 3);
One or more files in the format defined by the applications connected with the various objects to be exported.

The file is created in a proprietary format associated with an Export Runtime (2300) (FIG. 5) made available for download by the Central Management and Access subsystem. When the Export Runtime is executed, it opens the export file and gives to the receiving user the option of importing the object into their own instance of the system embodiment of the invention, if available, or to save in his local system the PDF or the various files produced by the Export service.

Indexing Service (1500b), continuously running in background. The Indexing Service scans the information inserted in the system either interactively by users, or by applications or other services, such as the import service, and performs two tasks:
Compares the input with all the existing nodes in the hierarchy and when a match is found, creates a link between the object containing the new data and the node in the hierarchy repository (1740). The system provides an “Automatic Link” attribute that can be set to ‘No’ by the user for specific objects to prevent the Indexing Service to perform this task against these objects;
Creates a full-text index that supports fast full-text search, as for example performed by Apple Spotlight. Also in this case a “Full-Text Search” attribute allows users to prevent the Indexing Service performing this action against specific objects.

A Macro Language (1500c), which users can access through a specific application. The macro language is a procedural language such as Microsoft Visual Basic for Application, which makes available the usual structures such as IF . . . THEN, FOR . . . NEXT, WHILE . . . DO, and also provides the special extensions to manage the entities of the systems embodiment of the invention. Special extensions include, but are not limited to:
Create, rename, copy, move and delete an object;
Read and write the content of an object;
Read and write an attribute of an object.

The code of the macro language is stored as content for a specific object and its content type (1750) is connected in the register of actions (1760) to the macro language application, with the actions that allow to edit and to run the code.

The Technology Foundation layer (1500) (FIG. 2) also implements Workflow Management (1500d), which functions to connect specific events to macro language objects and is configured through a dedicated application. The workflow management application allows users to identify an event, such as creation of an object, change of its content, change of value of an attribute, and associates the event with a macro language object that contains programming code that is automatically run when the event is detected. The association of macro language and workflow management allows users to program custom behaviors for their specific instance of the system, and create procedures to automatize repetitive tasks.

The Multiplatform Client (1000) (FIG. 2) also includes a Storage layer (1600), which manages the interface between the system and the various databases that the system can employ as storage, such as a local database (1700), a database stored in a public cloud (3000), or a connection to an external application (6000), created with a dedicated API (1800). The storage layer implements the following services:
Identification of the storage options: the users of the system can define where every object is stored. When an object is stored as a record in a database residing in the cloud, private or public, a synchronization option is made available and a mirror object is created in the local database. The synchronization option is recorded in a specific attribute of the object. Another connected attribute defines the timing for the synchronization and whether the synchronization is automatic or has to be triggered manually.
Authorization Management: including write and read permissions for nodes of the hierarchy that can be assigned to each registered user when working in a multi-user environment, for example when accessing sections of a hierarchy stored in a private cloud. Also, users can assign read and read-write passwords to objects for which they have the necessary authorization.
Lock and unlock of objects, for multi-users environments. An authorized user can lock a specific object, so that other users can't change it until the user unlocks it. Locks can be configured so that they expire automatically after a defined amount of time.
Versioning and Snapshot Management, activated through specific attributes, aimed at saving contents and attributes of objects linked to a section of a hierarchy at a defined point in time, or after a specific user request is triggered in the Object Navigator (1100). User-triggered snapshots can have a user-defined name. Users can access the content of the snapshots in different manners, made available through the Object Navigator, including:
   Navigate content and attributes of all the available snapshots for all the relevant objects;
   Activate a specific snapshot, and then perform the usual tasks, for example invoking an application. The application then operates on contents and attributes saved in the snapshot, rather than on the last version of the objects. Prior to any change to contents and attributes, the system automatically saves a new snapshot with the last version of the objects;
   Copy a snapshot to another node of the hierarchy,
   Fast backward the user sets a time, and the system activates for the selected section of the hierarchy all the snapshot saved immediately before the time indicated by the user.

Snapshots can also be stored in different locations, effectively providing back up and auditing services for the defined section of the hierarchy.

Synchronization of objects set for storage on a database residing in the cloud, to allow off-line access to the objects and multi-device replication.

A Local Database (1700) that the instances of the multiplatform client employ to store the hierarchy, objects and connected information on the device running the multiplatform client itself. FIG. 3 depicts an exemplary structure of the local database 1700 which is preferably locally accessible and includes, but is not limited to, the following:
Repository of all the objects (1730), including identification of the owning user to allow a secure connection with cloud repositories. Every object has a unique identifier that can be used to reference the object, for example to create a link between the object and a node in a hierarchical structure (FIG. 4);
Hierarchical structure 1740 including a plurality of nodes, e.g., 1741, 1742 . . . 1746;
Attributes (1720) that can be connected to objects, organized in a catalog (1710);
Local copy of the register of contents (1150), which is automatically updated by the Central Management and Access system when the user connects to it;
The register of the application accessible to the user (1770), and the register of all the actions (1760) that these applications can perform.

Information is stored in the Local Database 1700 for all the objects stored on the device in which the system is running, and for all the objects stored remotely in clouds for which a local synchronization setting is activated.

Hierarchical structures are aimed at allowing a proper organization of the objects, and every object must be linked to at least one node in the hierarchy. With reference to FIG. 4, the system manages both user—(1741) and system—(1744) managed sections in a hierarchy, both connected under a Root node, which is unique for every instance of the system. Objects are connected to the hierarchy through pointers, and therefore a single object can be connected with multiple nodes in the hierarchy. For example, an object containing a text document describing a meeting can be connected to nodes referring to its subject, to the date in which the meeting was held, and to the names of people who attended the meeting (FIG. 4).

User-managed sections of the hierarchy are freely definable and are used to structure the information managed by the systems embodiment of the present invention according to the need of each user. System-managed sections of the hierarchy include, but are not limited to, the most typical structures used to organize information, such as calendar, priorities, and contacts, and also include structures to manage technical information such as cloud access configurations.

Attributes are assigned to objects, based on an Attributes Catalog (1710) (FIG. 3), and are used by the systems embodiment of the present invention and by the applications developed in the framework of said systems, to store data that drive the behavior of the objects. Some exemplary attributes include: type of content, ID of the user who created the object, version of the object, data and time of creation, data and time of last update, position of the content in a slide, priority, location of storage (e.g.: local, private or public cloud), authorization profile, activation of automatic links to other objects through the Indexing Service.

A mechanism is provided to create a connection between an object in the hierarchy and an external file or Internet address through its URL (5000). When the content type (1750) of an object is assigned to the value “URL”, the content of the object can be set to the URL of an accessible entity identified by that URL. This allows the use to activate the entity, i.e.: open a web page or a file launching the application associated with the file extension. Objects with content type URL can also have other system- or user-defined attributes, for example to assign additional meta-information to external files.

An API for Content Providers (1800) (FIG. 2), allows programmers to build modules connecting an object of the system to information residing in an external application (6000). Modules created through the API for Content Providers are activated by objects whose content type is set at “External Provider”. The module can employ any system- or user-defined attribute of the object to store the information required to access the external system and retrieve, or write, the proper data. For example, a module create with the API for Content Providers can connect an object with a transaction of a business application such as SAP ERP, and the attributes of the object can contain the required parameters for the transaction. It is interesting to notice that the objects connected with external applications can still exploit all the standard features that the system makes available, including, for example, saving and storing snapshots of the contents.

The multiplatform client can include content providers for standard database connection methods such as ODBC, JDBC and MDX.

The Central Management and Access (CMA) system (2000) provides services to the active subsystems including the Multiplatform Clients (1000), and cloud systems (3000, 4000). The structure of the Central Management and Access system (2000) is depicted in FIG. 5. Its main components include, but are not limited to:
An App Store (2100) that makes available applications for download to active users through their respective connected multiplatform clients. The App Store also maintains the central Register of Apps (1770), which is a superset of the register with the same structure stored in each multiplatform client. Active users can employ their multiplatform clients to access the App Store included in the Central Management and Access system to search for new applications, and then download and install them inside their instance of the multiplatform client.
A Web Client (2200) that allows active users of the system to access reachable objects using a generic web browser connected to the Internet. When a user accesses the system through the Web Client, the following features and information are available:
   A Web Object Navigator that makes available the same functionalities of the Object Navigator of the multiplatform client;
   Objects stored as records in a database residing in reachable cloud systems for which the user has a valid configuration stored in the central User Register (2600);
   Applications already associated with the user for which a web access is available.
The Export Runtime (2300), which can be freely downloaded without any registration or prerequisite by anybody who needs to extract information from an Export file created by the Export service of the multiplatform client.
The Content Viewers (2400) for all registered applications, which are automatically downloaded by the multiplatform client when a user accesses an object with a content type not associated with any application in that particular instance of the multiplatform client. When a user accesses an object for which there is no valid web-enabled application associated with his profile in the User Register, the default Content Viewer is invoked.
A System Updater (2500) that whenever a multiplatform client is connected to the Central Management and Access system compares version numbers of the various components of the multiplatform client and of the installed applications, and gives the opportunity to download and install any available update. The System Updater also synchronizes the local and central Content Types (1750) catalogs.
A User Register (2600) that records all the active users of the system (i.e.: all the users that accessed the system and registered at least once, either through a multiplatform client or a web client). The User Register stores all the information required to provide secure services to the active users, including, but not limited to:
   The list of applications they downloaded and to which they have access when using the web client;
   The list of cloud connections the user wants to be able to access through the web client.
A Cloud Database (2700), which acts as a public cloud system available to all the active users of the system. The Cloud Database implements the same structure of the local repository depicted in FIG. 3.
A central register of all the available Content Types (1750) managed by the system, which is updated every time a new application introduces a new content type, and then replicated automatically in all the multiplatform clients through the standard update mechanism implemented by the System Updater.
A connected Private Cloud system (3000) allows active users of the system 100 to store defined sections of the hierarchy managed in their instance of the multiplatform client, including all the objects connected, in a remote, secure database, for example to create collaborative workgroup environments inside an organization. From an architectural standpoint, the Private Cloud system may be viewed as a subset of the Central Management and Access system (2000) that can include the following components:
   An App Store and Register of Apps, for applications developed by the organization running the Private Cloud for internal usage;
   A Web Client, for secure and fast web access to registered users;
   The User Register that stores authentication and configuration information for the users of the Private Cloud;
   A Cloud Database
A connected Public Cloud system (4000) allows active users of the system 100 to store defined sections of the hierarchy managed in their instance of the multiplatform client, including all the objects connected, in a remote, secure database, for example to enable synchronization among different devices belonging to the same user, as a back-up or to exchange information among users. From an architectural standpoint, the Public Cloud system is a subset of the Central Management and Access system that can include the following components:
   A Web Client, for secure and fast web access to registered users;
   The User Register that stores authentication and configuration information for the users of the Public Cloud;
   A Cloud Database.

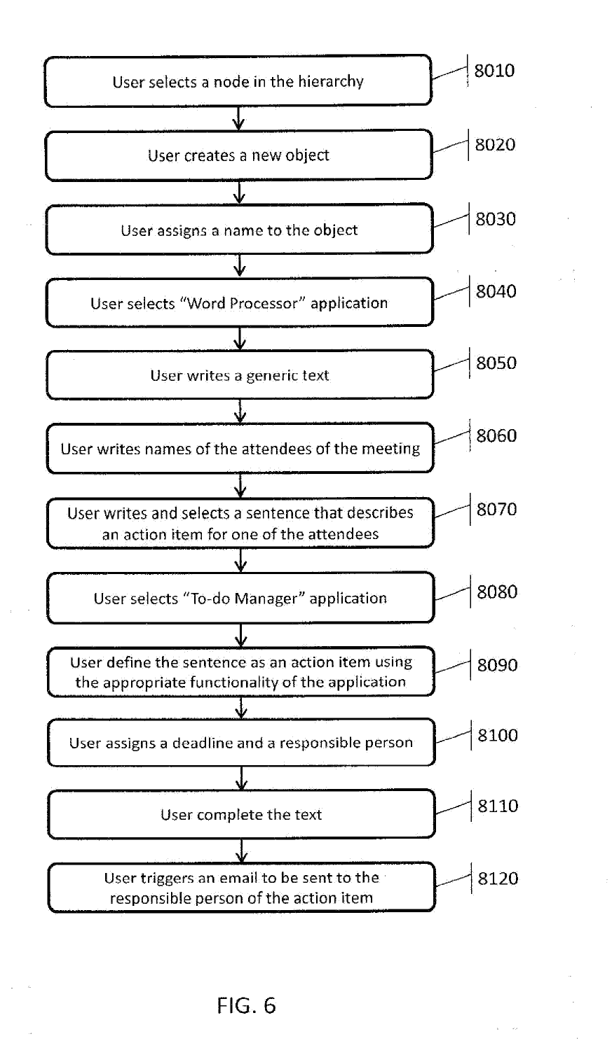

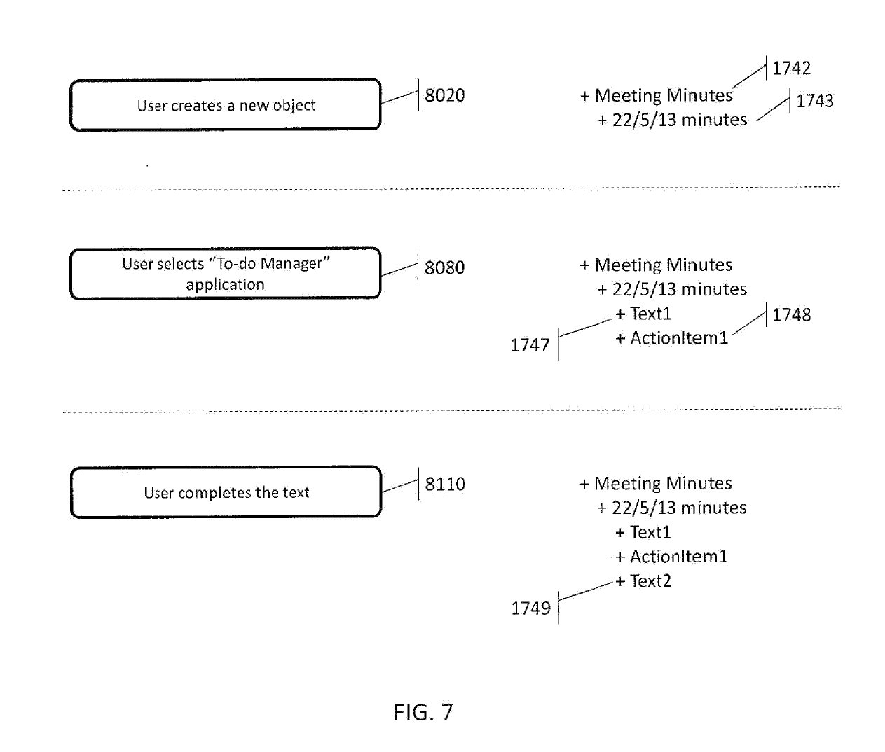

FIG. 6 comprises a workflow chart illustrating how a user can write a document including different categories of contents, e.g., the minutes for a business meeting, utilizing a system 100 in accordance with the invention. FIG. 7 illustrates the effect that the main steps of FIG. 6 have on the objects (1730) and hierarchy (1740) repositories.

The process starts at step 8010, where the user browses through the existing hierarchy of objects using the Object Navigator of a multiplatform client and identifies the appropriate node under which the new document has to be created (1742). This step can be compared to finding and selecting a folder in the file system according to the existing art.

At step 8020, the user employs a specific function of the Object Navigator and creates a new object. A number of actions are triggered in the system, including, but not limited to:
A new record (1743) is added to the object database (1730), and stored either locally, or in the private or public cloud according to the relative attribute of the hierarchy section to which the new object belong (as stated before, objects inherit the attributes of their parents). A unique ID is assigned to the object by the system;
System attributes for the newly created object are automatically set and stored in the relative repository (1720), including, but not limited to: user ID of the creator, date and time of creation, version.

This step does not have a direct comparison in known prior art systems because a file is typically associated with a specific application upon creation, and not as generic container of structured, multi-format contents as in the case of the systems in accordance with the invention.

At step 8030, the user assigns a name to the new object by invoking a specific function of the Object Navigator. A dialog box is open and the user type a text string, and then confirms the task. The attribute “Name” for the object is set with the content of the text string typed by the user. This step corresponds to the standard “File|Rename” functionality made available by operating systems, and to the “File|Save As . . . ” functionality made available by applications such as Microsoft Word.

At step 8040, the user selects an application among the ones registered in the relative repository (1770) of his specific instance of the multiplatform client. In this case the application selected is “Word Processor”. The application is loaded in the Object Navigator window, and its functionalities are activated. This step also triggers the creation of an association between the object and the default content type (1750) for this specific application. This step does not have a direct comparison in the existing art, because the application is selected upfront when the file is initially created, and can be only mildly compared to a functionality made available by Microsoft Office of inserting an object managed by a different application inside a file.

At step 8050, the user exploits the functionalities made available by the selected “Word Processor” application and writes a text. The text typed by the user, including its formatting characteristics, is saved as content for the selected object. The content of the object is also scanned by the system Indexing Service running in the background, and prepared for full-text search. This step corresponds to the standard activity performed by users leveraging applications such as Microsoft Word, and also to the full-text indexing services made available by operating systems such as Microsoft Windows and Apple OSX (Spotlight).

At step 8060, the user writes the names of the people attending the meeting. The system Indexing Service identify a match between the names written by the user and objects previously created by the user in the “Contacts” section of the hierarchy (1745), and links between the object open in the window and the relative objects identified in the hierarchy by the Indexing Service are created in the Hierarchy repository. This step does not have a direct comparison in the existing art.

At step 8070, the user writes a sentence that describes an action item for which responsibility has to be assigned to one of the people attending the meeting. The content of the object is updated to include the additional text. Then the user selects the sentence just written. This step corresponds to the standard activity performed by users leveraging applications such as Microsoft Word.

At step 8080, the user selects another application among the ones registered in the relative repository (1770) of his specific instance of the multiplatform client. In this case the application selected is “To-do Manager”. The application is loaded in the Object Navigator window, and its functionalities are activated. Moreover, since a text is already selected, this text is treated as input for the application. This step triggers the following actions performed by the system:
A first new object (1747) is automatically created in the objects repository (1730), having the previous object originally created by the user (1742) as parent in the hierarchy and the text previously entered by the user, except the selected sentence, as content. The new object inherits all the attributes of the parent object (1742) which becomes a container for both this object and the ones that will be created in the next steps under the same node of the hierarchy;
A second new object (1748) is automatically created in the objects repository (1730), having the previous object originally created by the user (1742) as parent in the hierarchy. As such, the new object inherits all the attributes of the parent object;
The default content type of the “To-do Manager” application is assigned to the second new object;
The selected text is assigned as content for the second new object.

This step does not have a direct comparison in the existing art. The closest available option is the “Copy-Paste|Link” functionality made available by some applications, that allow the transfer of content between different applications.

At step 8090, the user invokes a functionality of the “To-do Manager” application to set the selected text as an action item. A specific object attribute managed by the “To-do Manager” application is set to the corresponding value. This step corresponds to a standard operation in any application similar to the “To-do Manager” application.

At step 8100, the user invokes the functionalities of the “To-do Manager” application to assign a deadline and a responsible person to the action item. The responsible person is picked by a list connected with the object hierarchy “Contacts” (1745). The system creates a link in the hierarchy repository between the object and the appropriate nodes of the Contacts (1745) and Calendar (1746) sections of the hierarchy.

At step 8110, the user moves the focus (e.g.: moving the pointer of the mouse and clicking a mouse button) to the generic text area below the sentence previously identified as action item, and completes the text. This step triggers the creation of a new object (1749) in the object repository. This object is linked in the hierarchy repository to the original object (1742) created at step 8020 and is positioned sequentially after the two objects created at step 8080. This step does not have a direct comparison in the existing art.

At step 8120, the user moves the focus back to the action item (e.g.: moving the pointer of the mouse and clicking a mouse button) and invokes a “Send email to responsible person” functionality of the “To-do Manager” application. The application gives the user the option of selecting the part of the document to be included in the email, then the application creates an email, recalls the email address from the linked contact, put the selected text as content of the email, and the email is sent. In the existing art, this step is usually performed through a number of manual steps using different applications.

From the foregoing, it should now be understood that the invention comprises a computer system and method of operation wherein content is contained in application independent objects, preferably stored and managed as database records. Although, specific embodiments of the invention have been described herein, it should be understood that variations and modifications will readily occur to those skilled in the art which fall within the spirit and intended scope of the invention as defined by the appended claims.

What is claimed is:

1. A method of managing information represented by a multiplicity of application independent objects where each such object contains content data, the method comprising:
providing at least one database capable of storing a multiplicity of records;
storing said objects in said database such that each object uniquely relates to at least one record;
defining a hierarchy including a plurality of nodes;
linking each of said stored objects to at least one of said hierarchy nodes;
providing an attribute catalog defining a plurality of attributes;
linking each of said stored objects to at least one of said attributes;
providing a register identifying a plurality of applications and at least one action performable by each of said applications;
providing a register describing the content type of each of said stored objects and at least one action to be performed thereon; and
linking each of said stored objects to at least one of said applications dependent on the type of content data contained in the object.

2. The method of claim 1, further comprising linking said stored objects to nodes in the hierarchy based on matching between content of the object and name of the hierarchy node.

3. The method of claim 1, wherein said at least one database comprises multiple databases including: a local database and a cloud based database.

4. In combination with a computing device having a processor and memory, a computer system for managing personal and/or workgroup information comprising:
an information management subsystem executable by said computing device for processing multiple application independent objects where each such object contains defined content;
a hierarchical structure defining a plurality of nodes;
an attribute catalog defining a plurality of attributes;
a register identifying a plurality of applications; and
an object navigator providing a user interface for linking each of said objects to one or more of said nodes, said attributes, and said applications.

5. The computer system of claim 5 wherein said user interface comprises a web browser.

6. The client system of claim 5 wherein said user interface is configured for execution on a mobile device.

7. A method of operating a computing device having processor and memory functionality comprising:
defining multiple application independent objects where each such object contains content data of a defined content type;
providing a database capable of storing a multiplicity of records;
storing said objects in said database such that each object uniquely relates to at least one record:
providing a register identifying a plurality of different applications and at least one action performable by each of said applications; and
associating each stored object with at least one of said applications dependent on the type of content data contained therein.
